(19) United States
(12) Patent Application Publication
(10) Pub. No.: US 2003/0117741 A1
(43) Pub. Date: Jun. 26, 2003

(54) Method and apparatus for loading head onto disk medium from ramp in disk drive

(76) Inventor: Tatsuharu Kusumoto, Higashiyamato-shi (JP)

Correspondence Address: PILLSBURY WINTHROP, LLP, P.O. BOX 10500, MCLEAN, VA, 22102, US

(21) Appl. No.: 10/234,847

(22) Filed: Sep. 5, 2002

(30) Foreign Application Priority Data
Dec. 25, 2001 (JP) 2001-392672

(51) Int. Cl. G11B 21/02

(52) U.S. Cl. 360/75

(57) ABSTRACT

A CPU performs head load control to load a head above a disk from a ramp by speed feedback control when a nonoperating state of a disk drive is released. The CPU uses a value corresponding to an amount of VCM current necessary for moving the head from a parking area on the ramp during a predetermined period of time until the first sampling time of the speed feedback control as an initial value of a control variable (initial control variable) used for the speed feedback control.

### CROSS-REFERENCE TO RELATED APPLICATIONS

This application is based upon and claims the benefit of priority from the prior Japanese Patent Application No. 2001-392672, filed Dec. 25, 2001, the entire contents of which are incorporated herein by reference.

### BACKGROUND OF THE INVENTION

1. Field of the Invention

The present invention relates to a method and an apparatus favorable for loading a head above a disk medium from a ramp in a disk drive.

2. Description of the Related Art

A hard disk drive (HDD) that reads/writes data using a head is known as a disk drive that at least reads data using a head. The head is supported by an actuator for moving the head in the direction of the radius of the disk (disk medium). More specifically, the head is supported by a suspension extending from an arm of the actuator.

Most of recent hard disk drives adopt a ramp load system. This type of hard disk drive performs the following control when the drive changes into a nonoperating (idle) state. In other words, the control is that the head is retracted (unloaded) onto a ramp (ramp mechanism) provided outside the outer circumference of the disk and stopped in a recess formed on the ramp. The recess is called a parking area. Actually, it is not the head but a tab formed at the tip of the suspension for supporting the head that is stopped on the parking area of the ramp when the head is unloaded. Assume here that the head is stopped (parked) on the parking area of the ramp for the sake of brevity.

A hard disk drive adopting a ramp load system includes a latch (magnet latch) using, e.g., a magnet for regulating an operation of the actuator. The latch prevents the head from jumping out of the parking area of the ramp when the head is unloaded. In the hard disk drive, when the nonoperating state of the drive is released, the head is moved (loaded) above the disk medium from the parking area. The nonoperating state of the drive means not only a state in which the disk medium stops rotating but also a state in which no access request is issued from a host for a fixed period of time or longer though the disk medium is rotating. When no access request is issued from the host for the fixed period of time or longer, the supply of power to some circuits in the hard disk drive is generally stopped to reduce power requirements.

In the ramp load system, the head is stopped (parked) in a position where it is detached from the disk medium while the disk drive is in a nonoperating state, as described above. For this reason, there is no fear that the head collides with the disk medium even though the drive is externally vibrated in its nonoperating state. It is thus possible to prevent the head or disk medium from being damaged. There is no fear that the head adsorbs on the disk medium that stops rotating. Consequently, the ramp load system is effective in bringing the surface of the disk into good conditions and reducing the amount of elevation of the head to improving the recording density.

In the ramp load system, however, the head is detached from the disk medium for a given period of time when it is loaded/unloaded. Therefore, the head cannot read servo information from the disk medium. In this case, the position of the head cannot be detected based on positional information contained in the servo information, nor can be the speed of the head. Accordingly, the control (speed control) of the head cannot be performed when the head is loaded/unloaded.

The currently used hard disk drive, as disclosed in Jp. Pat. Appln. KOKAI Publication No. 2001-155455, performs the speed control (speed feedback control) of loading/unloading of a head by detecting the head speed from the back electromotive force voltage (back EMF voltage) of a voice coil motor (VCM). The voice coil motor is a driving source of an actuator that supports the head such that the head can move in the direction of the radius of the disk medium.

Open loop control for supplying a fixed amount of current (VCM current) to the voice coil motor of the actuator for a fixed period of time is usually performed to load the disk above the disk medium from the parking area on the ramp. The current supply to the voice coil motor is performed to cause the head to escape from the parking area by driving the actuator against the latch force of the latch (magnet latch). The amount of VCM current supplied to the voice coil motor for a fixed period of time is preset to such a value that the speed of the voice coil motor or the speed of the head can reach the fixed percentage (e.g., 50%) of the target speed. The fixed period of time is so determined that the head can move from the parking area on the ramp to another area thereon when the head speed reaches the fixed percentage of the target speed after a lapse of the fixed period of time. After the lapse of the fixed period of time, the open loop control shifts to the speed feedback control using the back EMF voltage of the voice coil motor.

When the speed feedback control starts, the head speed is not constant since the open loop control is performed prior to the speed feedback control. In the prior art, therefore, the initial value (initial control variable) of the speed feedback control is set at 0. If the speed feedback control starts while its initial control variable is set at 0, the head that escaped from the parking area looses speed by the open loop control. In this case, the head temporarily stops on the inclined surface of the ramp. Therefore, the loading of the head performed by the speed feedback control restarts from the position in which the head stops.

If the head is stopped on the inclined surface of the ramp when it is loaded as described above, the influence of static friction between the ramp and head becomes greater than that in the loading of the head from the parking area. In the prior art hard disk drive, therefore, it is difficult to cause the head to escape from the ramp. Furthermore, the open loop control allows the head to escape from the parking area of the ramp. For this reason, there occur variations in the head speed when the open loop control shifts to the speed feedback control or in the initial head speed when the speed feedback control starts. The variations cause the head speed to vary during the speed feedback control.

### BRIEF SUMMARY OF THE INVENTION

The present invention has been developed in consideration of the above situation and its object is to provide a disk drive that can prevent a head from stopping halfway on a ramp when the head is loaded above a disk medium from the ramp and perform stable speed feedback control without relying upon open loop control.

According to an aspect of the present invention, there is provided a method of loading a head of a disk drive above a disk medium from a ramp of the disk drive, the head being used to read information from a disk medium. The method comprises performing head load control to load the head above the disk medium from the ramp by speed feedback control and supplying a current corresponding to an initial control variable for the speed feedback control to a voice coil motor at the time of the speed feedback control. The initial control variable corresponds to an amount of current to be supplied to the voice coil motor to move the head from a parking area on the ramp during a given period of time from the start of the speed feedback control until the first sampling time of the speed feedback control. Performing the head load control includes generating a control variable to perform the speed feedback control every sampling time of the speed feedback control in accordance with a difference between a speed of the head and a target speed and supplying a current corresponding to the generated control variable to the voice coil motor.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a hard disk drive according to an embodiment of the present invention.

FIG. 2 is a view explaining a relationship in structure between a ramp and an actuator of the hard disk drive shown in FIG. 1.

FIG. 3 is a diagram showing that an initial control variable used for speed feedback control is stored in a FROM of the hard disk drive shown in FIG. 1.

FIG. 4 is a flowchart showing steps of head load control of the hard disk drive shown in FIG. 1.

FIG. 5A is a graph showing an example of variation of head speed with time at the time of head load control of the hard disk drive shown in FIG. 1.

FIG. 5B is a graph showing an example of variation of VCM current with time at the time of head load control of the hard disk drive shown in FIG. 1.

FIG. 6A is a graph showing an example of variation of head speed with time at the time of head load control of a prior art hard disk drive.

FIG. 6B is a graph showing an example of variation of VCM current with time at the time of head load control of the prior art hard disk drive.

FIG. 7 is a flowchart showing steps of determining an initial control variable used in the hard disk drive shown in FIG. 1.

FIG. 8 is a diagram showing an example of a data structure of an initial control variable table stored in the FROM of a modification to the hard disk drive shown in FIG. 1.

FIG. 9 is a flowchart showing some of steps of head load control of a modification to the hard disk drive shown in FIG. 1.

### DETAILED DESCRIPTION OF THE INVENTION

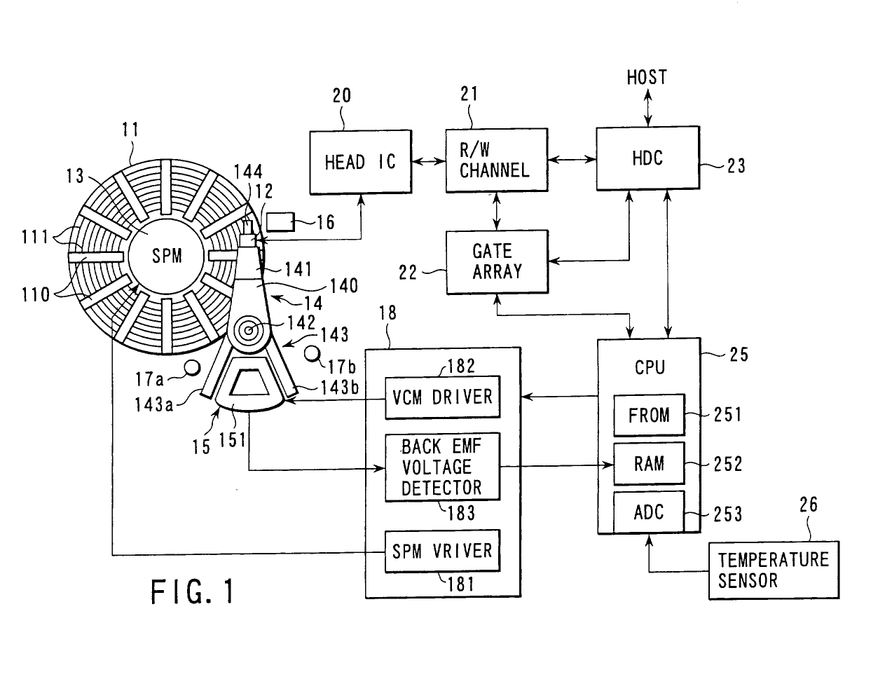

A hard disk drive (HDD) according to an embodiment of the present invention will now be described with reference to the accompanying drawings. FIG. 1 is a block diagram showing a configuration of the hard disk drive. As shown in FIG. 1, a disk (magnetic disk medium) 11 has upper and lower two disk surfaces. One or both of the disk surfaces of the disk 11 serve as recording surfaces on which data is magnetically recorded. A head (magnetic head) 12 is provided for each of the recording surfaces of the disk 11. The head 12 is used to write data to the disk 11 (data recording) and read data from the disk 11 (data reproduction). It is assumed in the configuration shown in FIG. 1 that the hard disk drive includes a single disk 11; however, the drive may have a plurality of disks 11 that are stacked one on another.

A plurality of servo areas 110 are arranged radially in the disk 11 and discretely at regular intervals in the direction of the circumference of the disk 11. Servo data is recorded on each of the serve areas 110. The servo data includes positional information necessary for seek control to move the head 12 to a target track and for head positioning control to position the head 12 within a target range of the target track. A user data area is formed between adjacent servo areas 110 and includes a plurality of data sectors (not shown). A number of concentric tracks 111 are formed on each of the recording surfaces of the disk 11.

The disk 11 is rotated at high speed by a spindle motor (referred to as SPM hereinafter) 13. The head 12 is attached to an actuator (carriage) 14 serving as a head moving mechanism. More specifically, the head 12 is attached to a suspension 141 extending from an arm 140 of the actuator 14. The head 12 moves in the direction of the radius of the disk 11 in accordance with the rotation of the actuator 14. Thus, the head 12 is positioned on the target track. The actuator 14 includes a voice coil motor (referred to as VCM hereinafter) 15 serving as a driving source of the actuator 14. The actuator 14 is driven by the VCM 15.

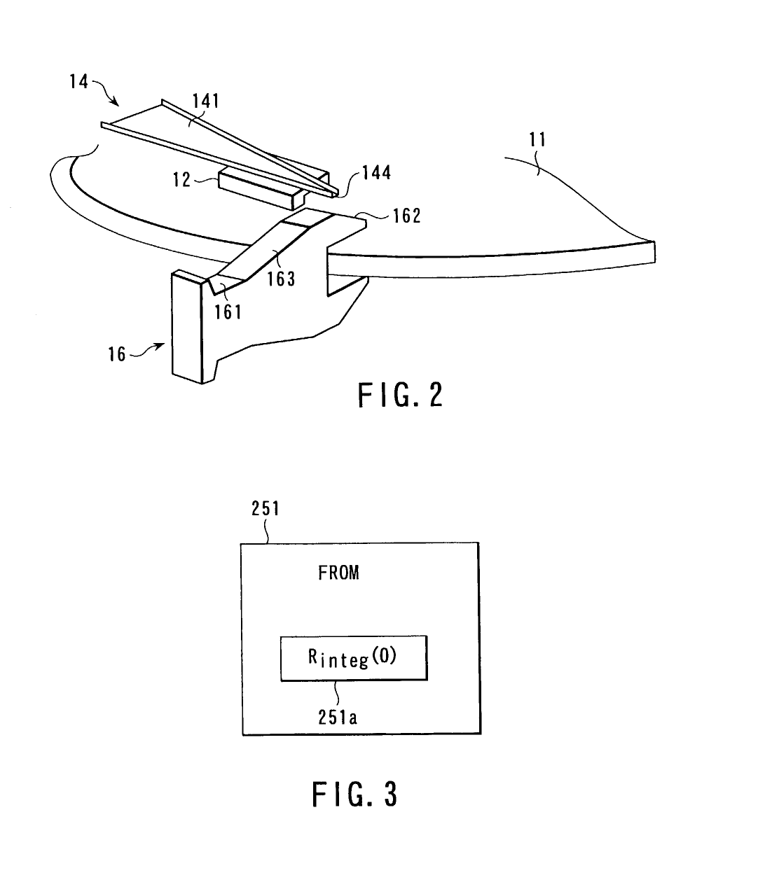

A ramp 16 is provided outside the outer circumference of the disk 11 in order to retract the head 12 when the HDD changes into a nonoperating state. Actually, it is not the head 12 but a tab 144 (see FIG. 2) formed at the tip of the actuator 14 for supporting the head 12 that is positioned on the ramp 16. For the sake of brevity, it is described here that the head 12 is retracted (unloaded, parked) onto the ramp 16. The nonoperating state of the HDD means not only a state in which the disk 11 stops rotating but also a state in which no access request is issued from a host for a fixed period of time or longer though the disk 11 is rotating, as described in the above Description of the Related Art.

FIG. 2 is a view explaining a relationship in structure between the ramp 16 and actuator 14 shown in FIG. 1. The ramp 16 is provided in a given position that is proximate to the outer circumference of the disk 11 as illustrated in FIG. 2. The given position is located on a route of the tab 144. The tab 144 is formed at the tip of the suspension 141 extending from the arm 140 of the actuator 14. The ramp 16 has a parking area 161 in which the tab 144 stops. The parking area 161 has a recess by which the head 12 is held on the ramp 16. The ramp 16 also has a first inclined surface 162 at one end that is close to the disk 11. The first inclined surface 162 allows the head 12 to smoothly move to the ramp 16 from above the disk 11 when the head 12 is unloaded. The ramp 16 also has a second inclined surface 163 that is formed adjacent to the parking area 161. The second inclined surface 163 allows the head 12 to smoothly move toward the disk 11 from the parking area 161 when the head 12 is loaded.

Referring again to FIG. 1, a pivot 142 is fitted into an inner hole that is formed in substantially the center of the actuator 14 and its lower end is fixed on the base of a housing of the HDD. The actuator 14 is supported rotatably around the pivot 142. The actuator 14 includes a V-shaped supporting frame 143. The supporting frame 143 extends in a direction opposite to the suspension 141. A coil (VCM coil) 151, which makes up part of the VCM 15, is fixed on the supporting frame 143.

The HDD shown in FIG. 1 includes a magnet latch 17a as a first latch mechanism for regulating an operation of the actuator 14. The magnet latch 17a prevents the head 12 from jumping out of the ramp 16 over the parking area 161 when the head 12 is retracted onto the parking area 161. The latch 17a is therefore located so as to latch one end of the V-shaped supporting frame 143, which is close to the disk 11, by the magnetic force thereof when the head 12 jumps out of the ramp 16 over the parking area 161. The HDD also includes a magnet latch 17b as a second latch mechanism for regulating an operation of the actuator 14. The magnet latch 17b prevents the head 12 from jumping out of the inner circumference of the disk 11 and colliding with the SPM 13. The latch 17b is therefore located so as to latch the other end of the V-shaped supporting frame 143, which is far from the disk 11, by the magnetic force thereof when the head 12 jumps toward the SPM 13 over the inner circumference of the disk 11. The latches 17a and 17b need not be magnet latches or latch mechanisms using magnetic force. For example, they can be mechanical latch mechanisms. Furthermore, the supporting frame 143 need not be in the shape of the letter V.

The SPM 13 and VCM 15 are driven by driving currents (SPM current and VCM current) supplied from a driver IC 18. The driver IC 18 includes an SPM driver 181, a VCM driver 182, and a back EMF voltage detector 183. The SPM driver 181 supplies an amount of SPM current designated by a CPU 25 to the SPM 13. The VCM driver 182 supplies an amount of VCM current designated by the CPU 25 to the VCM 15. The back EMF voltage detector 183 detects a back EMF voltage of the VCM 15.

The head 12 is connected to a head IC (head amplifier circuit) 20. The head IC 20 includes a read amplifier for amplifying a read signal read by the head 12 and a write amplifier for converting write data into write current. The head IC 20 is connected to a R/W channel (read/write IC) 21. The R/W channel 21 processes various types of signals. This signal processing includes a process of converting the read signal amplified by the head IC 20 from analog to digital. The signal processing also includes a process of encoding write data and a process of decoding read data. Further, the signal processing includes a process of extracting servo data from a binary read signal in response to a timing signal (gate signal) generated by a gate array 22.

The R/W channel 21 is connected to the gate array 22 and HDC (disk controller) 23. The gate array 22 extracts positional information from the servo data detected by the R/W channel 21 and holds it such that the CPU 25 can read it. The gate array 22 generates various timing signals necessary for reading/writing data from/to the HDD and detecting servo data by the R/W channel 21. The gate array 22 includes a register group (not shown) for control. The register group is assigned to some of memory areas of the CPU 25. The CPU 25 reads/writes data from/to the memory areas to which the register group is assigned, thereby controlling the gate array 22 and HDC 23.

The HDC 23 is connected to the host (host system) using the HDD shown in FIG. 1 and to the CPU 25. The host is digital equipment such as a personal computer. The HDC 23 has an interface control function of receiving a command (write command, read command, etc.) from the host and controlling data transfer between the host and HDC 23. The HDC 23 also has a disk control function of controlling data transfer between the disk 11 and HDC 23 through the R/W channel 21.

The CPU 25 contains a FROM (flash read only memory) 251, a RAM (random access memory) 252, and an ADC (AD converter) 253. The FROM 251 is a rewritable nonvolatile memory that previously stores control programs to be executed by the CPU 25. The RAM 252 provides a work area of the CPU 25 and the like. The output of a temperature sensor 26 for sensing the temperature of the HDD is connected to the input of the ADC 253. The ADC 253 converts a detection output of the temperature sensor 26 into a digital signal.

The CPU 25 is a main controller of the HDD. The CPU 25 controls the other components of the HDD in accordance with the control programs stored in the FROM 251. For example, the CPU 25 performs positioning control for positioning the head 12 within a target track based on the positional information extracted by the gate array 22. The CPU 25 also performs head load control for loading the head 12 above the disk 11 from the ramp 16 when the HDD shifts from a nonoperating (idle) state to a normal operating state. The CPU 25 also performs control for unloading the head 12 onto the ramp 16 from above the disk 11 when the HDD shifts from an operating state to a nonoperating state. In the present embodiment, speed feedback control is used for the head load control. The speed feedback control is executed based on the speed of the head 12 (head speed). The head speed is computed from the back EMF voltage detected by the back EMF voltage detector 183 in the driver IC 18. The initial value of an amount of control (initial control variable) R_{integ}(0) used in the speed feedback control is stored in advance in an area 251a of the FROM 251, as shown in FIG. 3.

An operation of the HDD shown in FIG. 1 will now be described, taking the head load control for loading the head 12 above the disk 11 from the parking area 161 of the ramp 16 as an example. First, the overview of the head load control will be summarized. When the head 12 is moved (loaded) above the disk 11 from the parking area 161, the CPU 25 computes a control variable necessary for the movement. The CPU 25 sets the computed control variable to the VCM driver 182 in the driver IC 18. Thus, the VCM driver 182 supplies a VCM current, which depends upon the set control variable, to the VCM 15 to operate the VCM 15. Consequently, the actuator 14 is driven and the head 12 supported by the actuator 14 is moved in the direction of the radius of the disk 11.

If the VCM 15 is operated by the supply of VCM current to the VCM 15 from the VCM driver 182, it generates a back EMF voltage. The back EMF voltage detector 183 in the driver IC 18 detects the back EMF voltage generated from the VCM 15. Then, the detector 183 converts the detected back EMF voltage into a digital signal and transmits it to the CPU 25. The back EMF voltage of the VCM 15 corresponds to the speed of the head 12 (head speed) as described in Jpn. Pat. Appln. KOKAI Publication No. 2001-155455. The CPU 25 detects (computes) the speed of the actuator 14 including the VCM 15 on the basis of the back EMF voltage of the VCM 15 detected by the back EMF voltage detector 183. The speed of the actuator 14 corresponds to that of the head 12 (head speed) supported by the actuator 14. Then, the CPU 25 computes a control variable of the VCM 15 such that the speed of the head 12 reaches a target speed, based on the detected head speed. As described above, the HDD shown in FIG. 1 includes a speed feedback control system to cause the speed of the head 12 to reach a target speed.

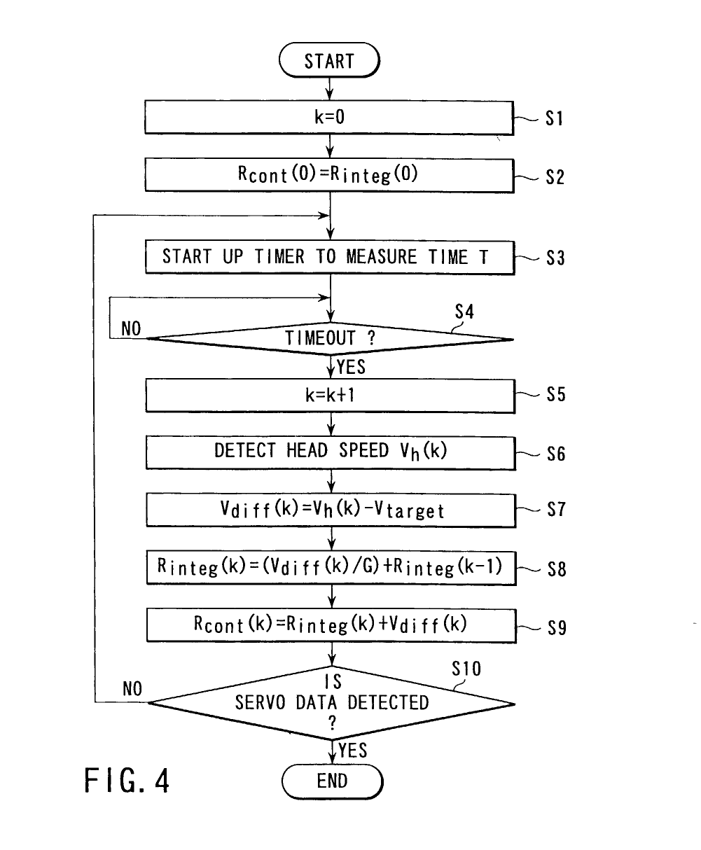

Head load control using the above speed feedback control system will now be described in detail with reference to the flowchart shown in FIG. 4. First, the CPU 25 sets a variable k indicating sampling time at the initial value 0 at the start of the head load control (step S1). Then, the CPU 25 sets the initial value (initial control variable) R_{cont}(0) of an amount of control R_{cont}(k) indicating a VCM current supplied to the VCM 15 to the VCM driver 182 (step S2). The initial value (initial control variable) R_{integ}(0) of an amount of control R_{integ}(k) used in the speed feedback control is used for the initial control variable R_{cont}(0). The initial control variable R_{integ}(0) is stored in advance in the area 251a of the FROM 251.

If the CPU 25 sets the initial control variable R_{cont}(0), the VCM driver 182 supplies the VCM 15 with the VCM current that depends upon the initial control variable R_{cont}(0) to thereby operating the VCM 15. The initial control variable R_{integ}(0) used as the initial control variable R_{cont}(0) is preset at such a value as to satisfy the following condition. The condition is that the initial control variable R_{integ}(0) corresponds to a VCM current value enough to cause the head 12 to escape (move) from the parking area 161 of the ramp 16 by the next sampling time (k=1) after a lapse of a one-sampling time period T. Naturally, the initial control variable R_{integ}(0) corresponds to a VCM current value enough to drive the actuator 14 by the VCM 15 against the force of the latch 17a, the static friction between the head 12 and the parking area 161 of the ramp 16, and the like.

The CPU 25 counts the one-sampling time period T using a timer (not shown) to advance the sampling time k by one (steps S3, S4 and S5). Then, the CPU 25 detects the speed (head speed) Vₕ(k) of the head 12 at new sampling time k (step S6). The head speed Vₕ(k) is detected (computed) from a value (digitally converted value) of the back EMF voltage of the VCM 15 that is detected by the back EMF voltage detector 183 at the sampling time k. In this case, the sampling time k means time (k=1).

The CPU 25 computes a speed difference (differential speed) V_{diff}(k) by the following equation (step S7):

V_{diff}(k)=Vₕ(k)−V_{target} (1)

where V_{target} is a target speed. As is apparent from the equation (1), the differential speed V_{diff}(k) is a difference of the head speed Vₕ(k) from the target speed V_{target} at the present sampling time k.

The CPU 25 evaluates a new control variable (integral) at the present sampling time k by the following equation (step S8):

R_{integ}(k)=(V_{diff}(k)/G)+R_{integ}(k−1) (2)

where G represents a gain (feedback gain) of the speed feedback control system and V_{diff}(k)/G indicates a value obtained by dividing the differential speed V_{diff}(k) computed in step S7 by the feedback gain G. In other words, the CPU 25 computes a control variable R_{integ}(k) by adding a control variable R_{integ}(k−1) used at the last sampling time k−1 to V_{diff}(k)/G.

The CPU 25 calculates a new control variable R_{cont}(k) at the present sampling time k by the following equation (step S9):

R_{cont}(k)=R_{integ}(k)+V_{diff}(k) (3).

More specifically, the CPU 25 computes the control variable R_{cont}(k) by adding the differential speed V_{diff}(k) calculated in step S7 to the control variable R_{integ}(k) obtained in step S8. In step S9, the CPU 25 sets the control variable R_{cont}(k) to the VCM driver 182.

Finally, the CPU 25 determines whether or not the R/W channel 21 detects servo data (step S10). This determination is made by checking whether or not the gate array 22 holds servo data. If the head 12 does not read servo data, the gate array 22 does not hold servo data and thus the CPU 25 determines that no servo data is detected. In this case, the CPU 25 determines that the head 12 does not yet reach above the disk 11 and returns to step S3 to continue speed feedback control for the head load control. The head 12 reads servo data soon and consequently the R/W channel 21 detects servo data. In this case, the CPU 25 determines that the head 12 escapes from the parking area 161 of the ramp 16 and reaches above the disk 11. In other words, the CPU 25 determines that the head 12 is loaded above the disk 11 from the ramp 16. The CPU 25 thus completes the head load control. After that, first seek control is done to move the head 12 to a given track (cylinder) on the disk 11.

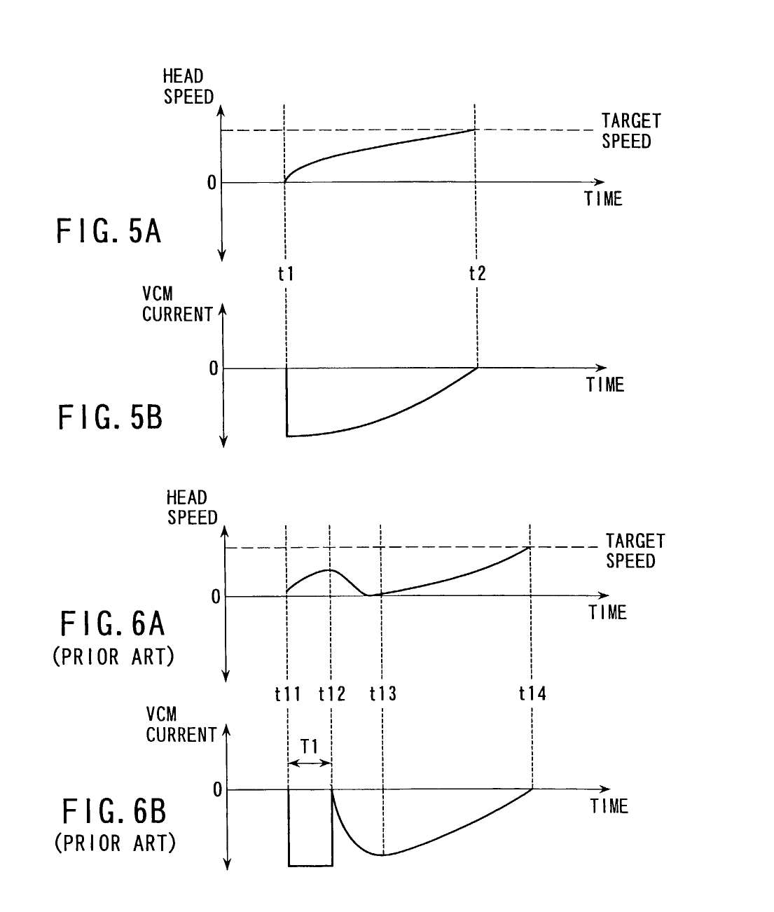

The feature of the foregoing head load control of the present embodiment will be described as compared with that of the prior art, with reference to FIGS. 5A and 5B and 6A and 6B. FIGS. 5A and 5B show an example of variations of head speed with time and that of variations of VCM current with time, respectively, at the time of the head load control of the present embodiment. FIGS. 6A and 6B show an example of variations of head speed with time and that of variations of VCM current with time, respectively, at the time of the head load control of the prior art.

In the prior art shown in FIGS. 6A and 6B, open loop control is performed from starting time t11 of the head load control until time t12 after a lapse of a predetermined period of time T1. In this open loop control, a predetermined VCM current is supplied to the VCM 15 irrespective of the state of the head 12. After the time t112, the open loop control shifts to the speed feedback control that is performed in accordance with head speed Vₕ(k). The head speed Vₕ(k) is detected based on the back EMF voltage of the VCM 15. As is apparent from the above equations (2) and (3), the control variable R_{cont}(1) used at the starting time (k=1) of the speed feedback control is expressed as follows:

$$\begin{matrix}{R}_{cont} ( 1 ) = {R}_{integ} ( 1 ) + {V}_{diff} ( 1 ) \\ = ( {V}_{diff} ( 1 ) / G ) + {R}_{integ} ( 0 ) + {V}_{diff} ( 1 )\end{matrix} \qquad ( 4 )$$

According to the prior art, since the actuator 14 does not undergo the feedback control during the time T1, the head speed varies from the starting time t12 of the speed feedback control to the starting time t12 of the speed feedback control. In the prior art, therefore, 0 is used in the control variable R_{integ}(0) at the starting time t12 of the speed feedback control and, in this case, the control variable R_{cont}(1) at the first sampling time (k=1) is given as follows from the above equation (4):

R_{cont}(1)=(V_{diff}(1)/G)+V_{diff}(1) (5)

It is apparent from the equation (5) that the control variable R_{cont}(1) is very small. If, therefore, the control variable R_{integ}(0) is set at 0 in order to shift the open loop control to the speed feedback control, the initial current value of the VCM current is approximate to zero. In the prior art, therefore, a lot of time is required to obtain a VCM current necessary for reaching the target speed, as shown in FIGS. 6A and 6B.

In the prior art shown in FIGS. 6A and 6B, the speed feedback control increases the head speed from time t12 when the open loop control ends until time t14 when the head speed reaches the target speed. In the speed feedback control, integration control starts from the time t12 when the initial control variable R_{integ}(0) (=0) is used. During a time period between t12 and t13 immediately after the speed feedback control starts, the head speed, which increased due to the preceding open loop control, lowers to nearly zero because of the shortage of VCM currents. The head 12 looses speed accordingly. After that, the head speed increases again if a sufficient VCM current is obtained by the speed feedback control.

In contrast, according to the present embodiment, the speed feedback control is used from the beginning of the head load control as described above. Moreover, an initial control variable R_{integ}(0) to allow the head to move at a speed other than 0 is used at the first sampling time (k=1) of the speed feedback control. In other words, a value necessary for causing the head 12 to escape from the parking area 161 of the ramp 16 is used for the initial control variable R_{integ}(0). The use of such an initial control variable can prevent the speed feedback control from starting from the initial current value (≈0).

In the present embodiment that uses the speed feedback control from the beginning of the head load control, as shown in FIGS. 5A and 5B, the speed feed back control increases the head speed from time t1 when the head load control starts until time t2 when the head speed reaches the target speed. Furthermore, the speed feedback control starts after a value necessary for causing the head 12 to escape from the parking area 161 of the ram 16 is set as the initial control variable R_{integ}(0) of the speed feedback control. In the present embodiment, therefore a VCM current can be produced as the value. Further, the variations in head speed become small since the speed feedback control is always performed in the head load control. As shown in FIG. 5A, the head 12 can continue accelerating (between t1 and t2) without approximating the head speed to zero or without losing speed during the head load control.

The latch force of the latch (magnet latch) 17a is likely to vary from HDD to HDD. Therefore, a value of VCM current necessary for causing the head 12 to escape from the parking area 161 by driving the actuator 14 latched by the latch 17a (referred to as escape current value hereinafter) varies from HDD to HDD. In the present embodiment, an escape current value is obtained at, for example, a normal temperature (25° C.) for each HDD to determine the initial control variable (initial integration value) of the speed feedback control. The determined initial control variable is stored in the area 251a of the FROM 251. This process is performed for each HDD during the manufacture of the HDD.

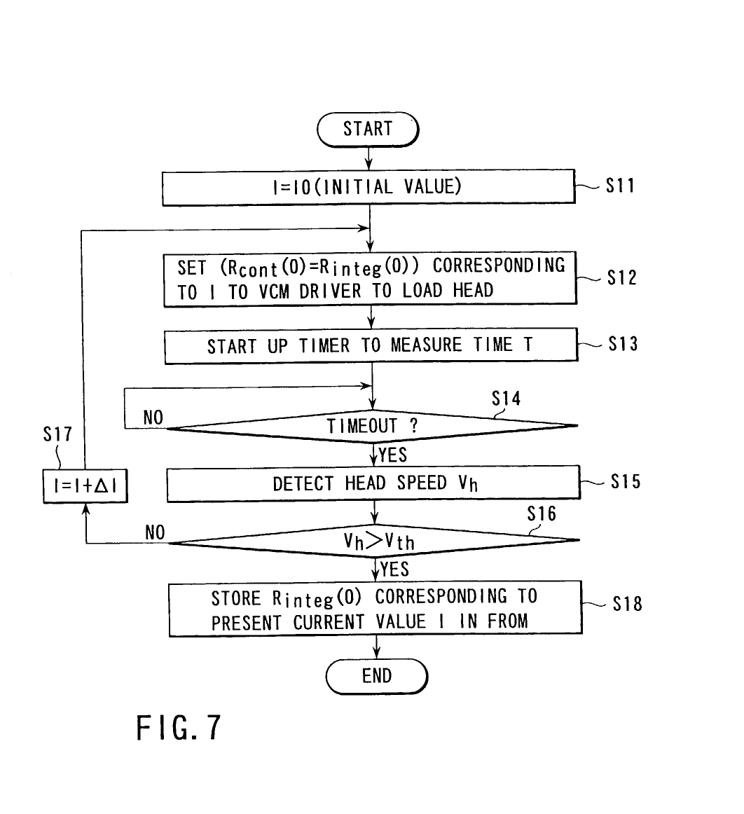

A process of determining the initial control variable in the present embodiment will now be described with reference to the flowchart shown in FIG. 7. First, the CPU 25 sets a variable I indicating a VCM current at the initial value I0 while the head 12 is parked on the parking area 161 of the ramp 16 (step S11). The initial value I0 is a design VCM current value enough to cause the head 12 to escape (move) from the parking area 161, before a one-sampling time period T elapses, by supplying the VCM current to the VCM 15 from the VCM driver 182.

Then, the CPU 25 sets a control variable R_{cont}(0) (=R_{integ}(0)), which corresponds to the present current value I (I=I0), to the VCM driver 182 in the driver IC 18 (step S12). Thus, the VCM driver 182 supplies the VCM 15 with a VCM current whose current value I depends upon the set control variable R_{cont}(0) to thereby operate the VCM 15. In other words, the CPU 25 sets the control variable R_{cont}(0) (=R_{integ}(0)) to the VCM driver 182 to try to cause the head 12 to escape from the parking area 161 of the ramp 16.

After that, the CPU 25 waits until a one-sampling time period T of the speed feedback control elapses (steps S13 and S14) and detects a head speed Vh as in the step S6 (step S15). Then, the CPU 25 determines whether the detected head speed Vh is higher than a preset reference speed Vth (Vth≧0) (step S16) If Vh is not higher than Vth, the CPU 25 increases the present current value I by a predetermined value (increment) ΔI (step S17). The CPU 25 executes the step S12 again based on the value I that is increased by ΔI. If Vh is higher than Vth, the CPU 25 determines that the present current value I is an escape current value of the corresponding HDD. The CPU 25 stores the control variable (integration value) corresponding to the present current value I in the area 251a of the FROM 251 as the initial control variable (initial integration value) R_{integ}(0) (step S18).

If the HDD is used for a long time, the surface of the parking area 161 becomes rough; therefore, the static friction of the parking area 161 is likely to increase. If the HDD is not used for a long time or if the actuator 14 is latched by the latch 17a for a long time, the force necessary for releasing the actuator 14 from its latched state is likely to increase. In this case, the above escape current value increases, too. If the escape current value increases, it is difficult to cause the head 12 to quickly escape from the ramp 16 even though the initial control variable (initial integration value) R_{integ}(0) corresponding to the escape current value obtained during the manufacture of the HDD is employed at the start of the speed feedback control. Taking into consideration a variation in escape current value with time, the initial control variable determination process according to the flowchart shown in FIG. 7 can be performed for each initialization of the HDD that is performed upon start-up of the HDD. Thus, the latest initial control variable R_{integ}(0) can always be used and, even though the escape current value varies with time, the head 12 can always be caused to quickly escape from the ramp 16 in the head load control. When the initial control variable determination process is performed for each initialization of the HDD, the initial control variable R_{integ}(0) need not always be stored in the FROM 251 but can be stored in, e.g., the RAM 252.

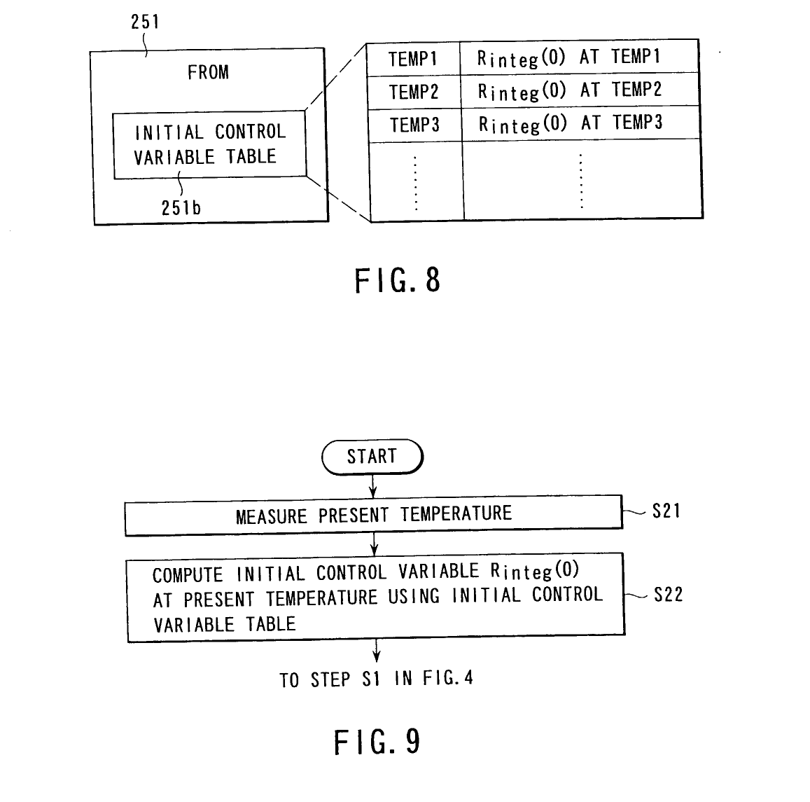

The foregoing embodiment is based on the premise that the escape current value hardly varies with the temperature of the HDD. However, the latch force of the latch 17a and the resistance of the coil of the VCM 15 have temperature dependence and so does the escape current value. Referring to FIGS. 8 and 9, a modification to the present embodiment will be described in which the initial control variable R_{integ}(0) used at the start of the speed feedback control for head load control is corrected (determined) in accordance with the temperature of the HDD. FIG. 8 is a diagram showing an example of a data structure of an initial control variable table stored in the FROM 251, and FIG. 9 is a flowchart showing some of steps of the head load control of the modification.

First, an initial control variable table is stored in advance in an area 251b of the FROM 251 as shown in FIG. 8. An initial control variable R_{integ}(0) is registered in the table for each of predetermined temperatures TEMP1, TEMP2, TEMP3 . . . The initial control variable R_{integ}(0) is easily obtained for each of the temperatures by performing the initial control variable determination process according to the flowchart shown in FIG. 7 while changing the temperature environment of the HDD.

According to the modification to the present embodiment, the CPU 25 reads the temperature TEMP of the HDD sensed by a temperature sensor 26 through the A/D converter 253 at the start of the head load control (step S21). Then, the CPU 25 computes an initial control variable R_{integ}(0) at the present temperature TEMP read in step S21, using the initial control variable table stored in the area 251b of the FROM 251 (step S22). For example, the following linear interpolation is used for the computation performed in step S22. Assume that the present temperature TEMP falls between temperatures TEMP1 and TEMP2 of the temperatures registered in the initial control variable table. In other words, assume that TEMP1<TEMP <TEMP2<TEMP3. In this case, the CPU 25 computes the initial control variable R_{integ}(0) that is optimum at the present temperature TEMP, since the initial control variable falling within a temperature range from TEMP1 to TEMP2 has linear temperature characteristics. In other words, the CPU 25 computes the initial control variable R_{integ}(0) that is optimum at the present temperature TEMP by linear interpolation using both the initial control variables at temperatures TEMP1 and TEMP2. When the CPU 25 computes the initial control variable R_{integ}(0) that is optimum at the present temperature TEMP in step S22, it performs the process of the head load control starting in step S1 in FIG. 4.

The initial control variable table can be updated by, e.g., initializing the HDD in consideration of variations in escape current value with time. As described below, the above linear interpolation can be used to update the initial control variable table. By performing the initial control variable determination process according to the flowchart shown in FIG. 7 in the initialization of the HDD, the CPU 25 computes the initial control variable at the temperature (present temperature) TEMP of the HDD. Then, the CPU 25 computes a difference between the initial control variable at the present temperature TEMP and that obtained by the above linear interpolation. The initial control variable table is thus updated by adding the difference to the initial control variable of each of temperatures TEMP1, TEMP2, TEMP3, . . . registered in the table. The updated table is the latest that is suitable for the present state of the HDD.

According to the configuration shown in FIG. 1, the temperature sensor 26 is connected to the CPU 25. However, the sensor 26 can be connected to the gate array 22 and, in this case, the CPU 25 reads the temperature sensing results of the temperature sensor 26 through the gate array 22.

According to the above embodiment and modification, the present invention is applied to an HDD (hard disk drive). However, it can be applied to a disk drive other than the HDD, such as a magneto-optical drive if it has only to include a ramp on which a head used for reading data from a disk medium is parked.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of loading a head of a disk drive above a disk medium from a ramp of the disk drive located outside an outer circumference of the disk medium, the head being used to read information from the disk medium, the method comprising:
performing head load control to load the head above the disk medium from the ramp by speed feedback control, the performing including generating a control variable to perform the speed feedback control every sampling time of the speed feedback control in accordance with a difference between a speed of the head and a target speed and supplying a current corresponding to the generated control variable to a voice coil motor, the voice coil motor serving as a driving source of an actuator which supports the head movably in a radial direction of the disk medium; and
supplying a current corresponding to an initial control variable to perform the speed feedback control to the voice coil motor at a start of the speed feedback control, the initial control variable corresponding to an amount of current to be supplied to the voice coil motor to move the head from a parking area on the ramp during a predetermined period of time from the start of the speed feedback control until first sampling time of the speed feedback control.

2. A method according to claim 1, further comprising detecting a speed of the head every sampling time of the speed feedback control based on a back electromotive force voltage generated from the voice coil motor.

3. A method according to claim 1, further comprising:
measuring the initial control variable during manufacture of the disk drive; and
storing the measured initial control variable in a storage unit.

4. A method according to claim 3, further comprising:
measuring a temperature of the disk drive at a start of the speed feedback control; and
determining an initial control variable to be used at the start of the speed feedback control based on the measured temperature and the initial control variable stored in the storage unit.

5. A method according to claim 3, wherein the initial control variable measuring includes:
supplying a current to the voice coil motor for the predetermined period of time in order to move the head from the parking area on the ramp;
detecting a speed of the head after a lapse of the predetermined period of time;
determining whether the detected speed of the head exceeds a reference speed;
causing the supplying of current for the predetermined period of time to be performed again by changing an amount of the current when the detected speed of the head does not exceed the reference speed; and
determining the initial control variable based on the amount of the current supplied to the voice coil motor when the detected speed of the head exceeds the reference speed.

6. A method according to claim 1, further comprising:
measuring the initial control variable at each of a plurality of preset temperatures during manufacture of the disk drive;
storing the initial control variable measured at each of the preset temperatures in a storage unit;
measuring a temperature of the disk drive at a start of the speed feedback control; and
determining an initial control variable corresponding to a present temperature to be used at a start of the speed feedback control, based on the measured temperature and the initial control variable stored in the storage unit.

7. A method according to claim 1, further comprising:
measuring the initial control variable every time the disk drive starts up; and
storing the measured initial control variable in a storage unit.

8. A method according to claim 7, wherein the initial control variable measuring includes:
supplying a current to the voice coil motor for the predetermined period of time in order to move the head from the parking area on the ramp;
detecting a speed of the head after a lapse of the predetermined period of time;
determining whether the detected speed of the head exceeds a reference speed;
causing the supplying of current for the predetermined period of time to be performed again by changing an amount of the current when the detected speed of the head does not exceed the reference speed; and
determining the initial control variable based on the amount of the current supplied to the voice coil motor when the detected speed of the head exceeds the reference speed.

9. A disk drive which reads information from a disk medium using a head, comprising:
an actuator which supports the head movably in a radial direction of the disk medium using a voice coil motor as a driving source;
a driver which drives the voice coil motor by supplying a current corresponding to a set control variable to the voice coil motor;
a ramp provided outside an outer circumference of the disk medium, the head being parked on the ramp in a nonoperating state of the disk drive;
means for when the nonoperating state of the disk drive is released, performing head load control to load the head above the disk medium from the ramp by speed feedback control based on a difference between a speed of the head and a target speed, the performing means including first setting means for setting a control variable corresponding to the difference between the speed of the head and the target speed every sampling time of the speed feedback control; and
second setting means for setting an initial control variable used for the speed feedback control to the driver at a start of the speed feedback control by the performing means, the initial control variable corresponding to an amount of current to be supplied to the voice coil motor to move the head from a parking area on the ramp during a predetermined period of time from the start of the speed feedback control until first sampling time of the speed feedback control.

10. A disk drive according to claim 9, further comprising a back electromotive force voltage detector which detects a back electromotive force voltage generated from the voice coil motor and wherein the performing means includes means for detecting a speed of the head every sampling time of the speed feedback control based on a detection result of the back electromotive force voltage detector.

11. A disk drive according to claim 9, further comprising:
means for measuring the initial control variable during manufacture of the disk drive; and
a storage unit configured to store the measured initial control variable by the measuring means.

12. A disk drive according to claim 11, further comprising:
a temperature sensor which senses a temperature of the disk drive; and
means for determining an initial control variable to be set to the driver by the second setting means based on a present temperature sensed by the temperature sensor and the initial control variable stored in the storage unit at the start of the speed feedback control.

13. A disk drive according to claim 11, wherein the measuring means includes:
means for supplying a current to the voice coil motor from the driver for the predetermined period of time in order to move the head from the parking area on the ramp;
means for detecting a speed of the head after a lapse of the predetermined period of time;
means for determining whether the detected speed of the head exceeds a reference speed;
means for causing the means for supplying a current for the predetermined period of time to be performed again by changing an amount of the current when the detected speed of the head does not exceed the reference speed; and
means for determining the initial control variable based on the amount of the current supplied to the voice coil motor when the detected speed of the head exceeds the reference speed.

14. A disk drive according to claim 9, further comprising:
means for measuring the initial control variable used for the speed feedback control at each of a plurality of preset temperatures during manufacture of the disk drive;
a storage unit configured to store the initial control variable measured at each of the preset temperatures by the measuring means;
a temperature sensor which senses a temperature of the disk drive; and
means for determining an initial control variable to be set to the driver by the second setting means, based on a present temperature sensed by the temperature sensor and the initial control variable stored in the storage unit at each of the preset temperatures, at a start of the speed feedback control.

15. The disk drive according to claim 9, further comprising:
means for measuring the initial control variable every time the disk drive starts up; and
a storage unit configured to store a latest measured initial control variable measured by the measuring means.

16. A disk drive according to claim 15, wherein the measuring means includes:
means for supplying a current to the voice coil motor from the driver for the predetermined period of time in order to move the head from the parking area on the ramp;
means for detecting a speed of the head after a lapse of the predetermined period of time;
means for determining whether the detected speed of the head exceeds a reference speed;
means for causing the means for supplying a current for the predetermined period of time to be performed again by changing an amount of the current when the detected speed of the head does not exceed the reference speed; and
means for determining the initial control variable based on the amount of the current supplied to the voice coil motor when the detected speed of the head exceeds the reference speed.
